(19) United States
(12) Patent Application Publication
(10) Pub. No.: US 2007/0012204 A1
(43) Pub. Date: Jan. 18, 2007

(54) Stencil printer

(75) Inventor: Mitsuo Sato, Miyagi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 11/436,618

(22) Filed: May 19, 2006

(30) Foreign Application Priority Data
Jul. 15, 2005 (JP) 2005-207698

(51) Int. Cl. B41L 13/00

(52) U.S. Cl. 101/118

(57) ABSTRACT

A stencil printer of the present invention prints an image on a paper sheet or similar sheet by use of UV (UltraViolet)-curing ink. The stencil printer includes a UV radiating device including a casing 32. A first and a second sheet sensor are so located as to be able to determine whether or not the sheet is remaining in the casing. At lest one of the two sheet sensors is implemented as a reflection type sensor made up of an IR (InfraRed) emitter and an IR sensor.

### BACKGROUND OF THE INVENTION

1. Field of the Invention

The present invention relates to a stencil printer and more particularly to a stencil printer of the type using UV (ultraviolet)-curing ink.

2. Description of the Background Art

Generally, a stencil printer, which is low in running cost and operable at high speed, is extensively used for producing, e.g., various kinds of items for distribution, formats, advertising circulars and business communications in an education market and organizations including industries, associations and hospitals and so forth. To allow anyone to operate the stencil printer anytime, the stencil printer usually uses ink of the type not curing in the air so as to save time and labor for cleaning a print drum each time.

The problem with the ink of the type described falsely dries by infiltrating into paper sheets and therefore easily smears resulting prints when rubbed just after printing. Although such a problem has long been pointed out, no drastic solutions have been practiced yet.

Japanese utility model publication No. 4-35188 and Japanese laid-open patent publication No. 5-64878, for example, propose a stencil printer including a UV radiating device and using a UV-curing ink and a UV radiating device configured to radiate UV rays toward a print. More specifically, the above publication No. 4-35188 teaches that a UV radiating device is positioned at the paper outlet of a stencil printer and that a shield member, included in the UV radiating device, is held in an operative position while a print drum is in rotation in order to prevent UV rays from leaking toward the print drum. On the other hand, laid-open publication No. 5-64878 teaches a device serving as a sheet conveyor and a UV radiating device at the same time and connectable to the sheet outlet of a stencil printer.

However, a conventional UV radiating device, positioned at a sheet conveying section adjoining the outlet of a stencil printer, must meet two contradictory requirements at the same time, as will be described hereinafter. If a cover portion, included in the UV radiating device fails to prevent UV rays emitted from a UV lamp from leaking to the outside, then the UV rays undesirably reach a print drum and cause UV-curing ink to cure while leaking to the outside of the stencil printer. Although a gap in the cover portion may be reduced as far as possible in order to obviate the leakage of the UV rays emitted from the UV lamp, a small gap is likely to cause a sheet to jam a sheet path at the cover portion.

Further, because a low-quality or a relatively thin paper sheet is usually applied to stencil printing, the resulting print noticeably deforms if a solid image, for example, formed thereon has a large area, resulting in a sheet jam. In addition, the print is apt to deform or curl due to heat ascribable to the UV rays and therefore apt to fail to pass a small gap, also resulting in a sheet jam.

When the print jams the sheet path inside of the cover portion, it is likely that the print is discolored, caused to wave or otherwise damaged if an adequate measure is not taken. This problem is brought about by the application of high power of 200 V, 3 kW level to the UV lamp, which is high enough to insure sufficient UV-curing.

### SUMMARY OF THE INVENTION

It is an object of the present invention to provide a stencil printer of the type using UV-curing ink and capable of obviating a sheet jam in a UV radiating device.

A stencil printer of the present invention includes a stencil printing section including a hollow, cylindrical print drum around which a master is to be wrapped. A conveyor conveys a paper sheet or similar sheet moved away from the stencil printing section. A UV radiating device faces the conveyor and radiates UV rays toward the image surface of the sheet. Sheet sensors, included in the conveyor, cooperate to sense the passage of the sheet through the UV radiating device. A controller immediately turn off, when the sheet sensors determines that the sheet is not accurately passed through the UV radiating device, UV lamps included in the UV radiating device, continuously drives the conveyor for a preselected period of time after the turn-off of the UV lamps, and stop driving the conveyor on the elapse of the preselected period of time.

### BRIEF DESCRIPTION OF THE DRAWINGS

The above and other objects, features and advantages of the present invention will become more apparent from the following detailed description taken with the accompanying drawings in which:

FIG. 1 is a view showing the general construction of a stencil printer embodying the present invention;

FIG. 2 is a view showing a UV radiating device included in the illustrative embodiment and arrangements around it;

FIG. 3 is a view similar to FIG. 2, showing a modification of the UV radiating device;

FIG. 4 is a fragmentary front view showing an outlet roller included in the illustrative embodiment;

FIG. 5 shows a gap formed between a casing included in the UV radiating device and the outlet roller;

FIG. 6 shows a gap formed when the outlet roller is absent;

FIG. 7 is a timing chart demonstrating a specific operation of a second sensor responsive to a sheet remaining in the UV radiating device;

FIG. 8 is a table listing specific values of a preselected period of time t1 determined by a sheet conveying speed and a sheet size in a direction of sheet conveyance;

FIG. 9 is a schematic block diagram showing a control system included in the illustrative embodiment; and

FIGS. 10A-10C are flowcharts demonstrating a specific operation of the control system.

### DESCRIPTION OF THE PREFERRED EMBODIMENT

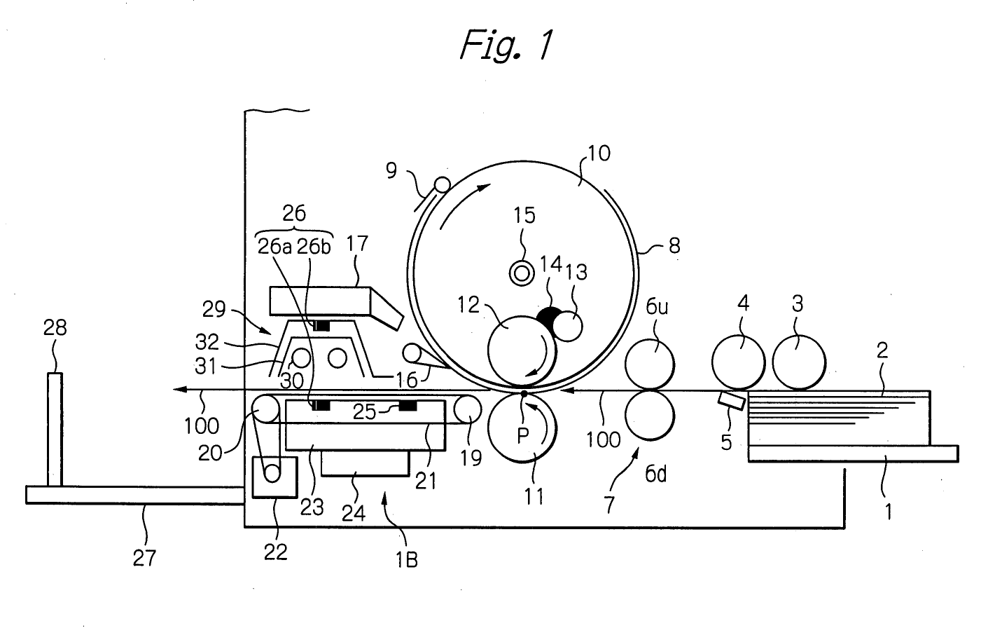

A preferred embodiment of the stencil printer in accordance with the present invention will be described hereinafter. FIG. 1 shows the construction of part of the stencil printer embodying the present invention. As shown, the stencil printer includes a pickup roller 3, a reverse roller 4 and a pad 5 constituting separating means for paying out paper sheets or similar sheets 2 stacked on a sheet feed table 2 while separating them one by one.

In operation, the top paper sheet on the sheet feed table 1 is paid out by the above sheet separating means while being separated from the underlying paper sheets and conveyed toward a registration roller pair 7 in a direction indicated by an arrow 100 in FIG. 1. The registration roller pair 7, i.e., an upper and a lower registration roller 6u and 6d, respectively, are positioned downstream of the sheet separating means and configured to stop the paper sheet 2 in order to correct skew thereof and then convey it toward a printing position P at preselected timing such that the leading edge of the paper sheet 2 meets the leading edge of an image formed in a stencil 8.

More specifically, the printing position A is located between a hollow, cylindrical print drum 10 and a press roller 11. The stencil 8 perforated, or cut, in accordance with image data, i.e., a master 8 is wrapped around the print drum 10 beforehand. The stencil 8 is retained on the circumferential surface of the print drum 10 with its leading edge clamped by a clamper 9. The print drum 10 is rotated clockwise by a drive mechanism, not shown, as indicated by an arrow in FIG. 1. The press roller 11 is rotated counterclockwise, as also indicated by an arrow in FIG. 1, while pressing the paper sheet 2 against the master 8 wrapped around the print drum 10.

An ink roller 12 and a doctor roller 13 are disposed in the print drum 10 and spaced from each other by a preselected gap. UV-curing ink is fed via an ink feed pipe 15, which plays the role of a print drum shaft at the same time, forming an ink well 14 between the ink roller 12 and the doctor roller 13.

The UV-curing ink is fed from the ink well 14 to the porous inner periphery of the print drum 10 via the gap mentioned above by the ink roller 12. At the printing position P, the ink is transferred to the surface of the sheet 2 via the porous portion of the print drum 10 and perforations formed in the master 8, forming an image on the sheet 2.

Subsequently, the paper sheet 2, carrying the image thereon, is peeled off from the print drum 10 by a peeler 16 and the pressure of air sent by a fan 17 and then conveyed by a conveyor 18 leftward, as indicated by the arrow 100 in FIG. 1.

The conveyor 18 includes a drive motor 22, a suction duct 23 and a suction fan 24. An endless belt 21 is passed over a drive roller 20, which is driven by the drive motor 22, and a driven roller 19 and implemented by a plurality of parallel, thin sheets formed of metal. The drive roller 20 causes the belt 21 to turn when driven by the drive motor 22. The suction duct 23 and suction fan 24 are configured to retain the paper sheet 2 on the belt 21 by sucking the reverse surface of the paper sheet 2.

A first sensor 25 and a second sensor 26 are arranged at the upstream side and downstream side, respectively, with respect to a sheet path represented by the arrow 100 and play the role of sheet sensing means for sensing the paper sheet 2 being conveyed on the sheet path 100. More specifically, the first sensor 25 is implemented as a reflection type sensor positioned in the radiation range of a UV radiating device 29, which will be described specifically later, but outside of the casing of the device 29 at the upstream side with respect to the sheet path 100.

The second sensor 26 is disposed in the casing of the UV radiating device 29 in the radiation range of the device 29 and made up of an IR (InfraRed) emitter 26a and an IR sensor 26b.

When the paper sheet 2 is present on an optical path between the IR emitter 26a and the IR sensor 26b, IR rays emitted from the IR emitter 26a do not reach the IR sensor 26b, indicating that a sheet jam has occurred. The IR sensor 26b is of the type not detecting V rays emitted from UV lamps 30, which will be described later specifically, even when the UV rays are incident thereon.

The paper sheet or print 2, conveyed by the conveyor 18, is stacked on a print tray 27. An end fence 28 is mounted on the print tray 27 in order to stop the leading edge of the paper sheet in the direction 100 for thereby positioning the paper sheet 2.

The UV radiating device 29 for radiating UV rays toward the image surface of the paper sheet 2 is arranged above the conveyor 18. The UV radiating device 29 includes the UV lamps 30 mentioned earlier, a reflector 31 formed of, e.g., aluminum and a casing or cover member 32 positioned outside of the reflector 31. The UV lamps 30 may be implemented as metal halide lamps by way of example.

The casing 32 has a generally U-shaped section and is positioned above the endless belt 21 in such a manner as to surround or cover the UV lamps 30 with its open end facing downward. In addition, an air discharge pipe, a suction fan and so forth are so arranged as to suck air inside the casing 32 and then discharge it to the outside via an ozone filter, although not shown specifically.

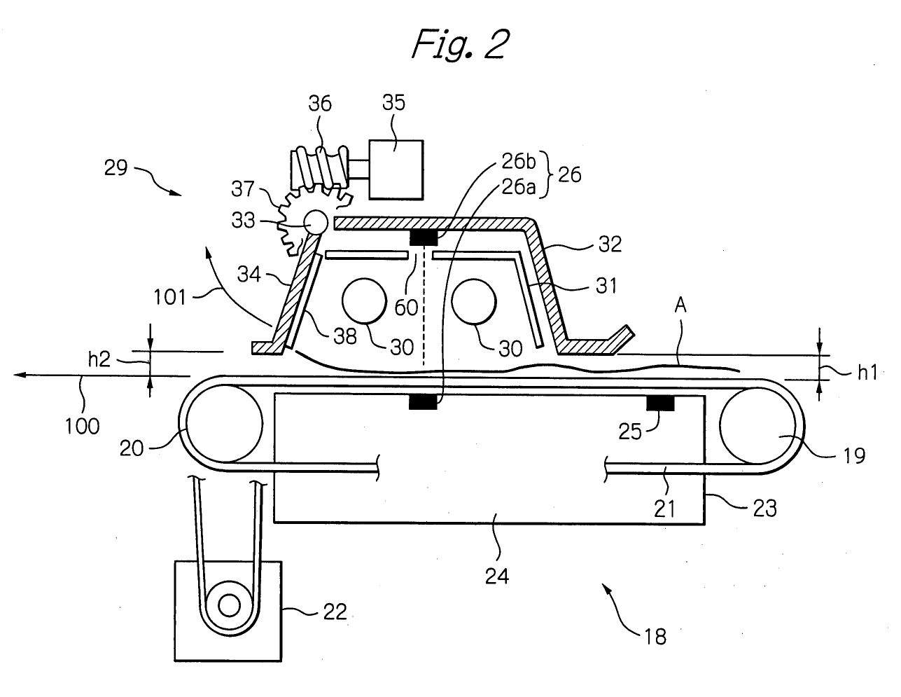

FIG. 2 shows the UV radiating device 29 and arrangements around it in an enlarged scale. As shown, two UV lamps 30 are positioned parallel to each other in the direction 100. The reflector 31 surrounds the UV lamps 30 while the casing 32 surrounds the reflector 31.

An opening 60 is formed in part of the reflector 31 in alignment with the IR sensor 26b mounted on the inner surface of the top wall of the casing 32. A shaft 33 is rotatably supported by one end of the casing 32, the left end in FIG. 2 in the illustrative embodiment, and extends in the direction perpendicular to the sheet surface of FIG. 2. An openable cover 34 is affixed to the shaft 33 and therefore angularly movable in accordance with the rotation of the shaft 33.

A worm gear 37 is affixed to the shaft 33 while a worm 36 is held in mesh with the worm gear 37 and driven by a drive motor 35. When the worm 36 is rotated by the drive motor 35, it causes the worm gear 37 to rotate. As a result, the cover 34 is angularly moved together with the shaft 33 in a direction indicated by an arrow 101 in FIG. 2, opening part of the casing 32. A reflector 38 is mounted on the inner surface of the cover 34. The paper sheet 2 is conveyed by the endless belt 21 in the direction 100 while being retained on the belt 21 by suction.

As stated above, the casing 32, resembling a cup having a generally U-shaped section, accommodates the UV lamps 30 and is affixed to the body of the stencil printer with its open end facing the belt 21. A gap that allows the paper sheet 2 to pass therethrough is formed between the casing 21 and the belt 21.

Air sucked via gaps between the metallic thin sheets, which constitute the belt 21 in combination, allows the paper sheet 2 to be surely conveyed by the belt 21 while being retained thereon. A gap h1, forming part of the gap between the casing 32 and the belt 21 at the upstream side on the sheet path 100, should preferably be as small as possible in order to prevent UV rays emitted from the UV lamps 30 from leaking to the outside via the gap between the belt 21 and the end portion of the casing 32 as far as possible. This is also true with a gap h2 that forms another part of the above gap at the downstream side on the sheet path 100.

Should the UV rays from the UV lamps 30 be incident on the print drum 10 via the gap h1, they would cause the ink on the print drum 10 to locally cure and obstruct the passage of further ink, resulting in defective image formation. Further, should the UV rays from the UV lamps 30 leak to the outside via the gap h2 at the downstream side, they would leak to the outside of the stencil printer via a sheet outlet formed in the body of the stencil printer and adjoining the print tray 27.

However, if the gaps h1 and h2 are made small, it is likely that the paper sheet or print, labeled A in FIG. 2, is caught by the casing 32 or the openable cover 34 and jams the sheet path 100, as illustrated. The jam is particularly serious if the leading edge of the paper sheet A enters the UV radiating device 29 and cannot get thereoutof. In this condition, the downstream portion of the paper sheet A faces the UV lamps 30 and are discolored, caused to wave or otherwise damaged by heat of the UV lamps 30.

In light of the above, in the illustrative embodiment, when the first sensor 25 turns on by sensing the paper sheet A, but does not turn off in a preselected period of time, or when the first sensor 25 turns on by sensing the paper sheet A, but the second sensor 26 does not sense the paper sheet A in a preselected period of time or when the second sensor 26 turns on by sensing the paper sheet A, but does not turn off in a preselected period of time, it is determined that a sheet jam has occurred.

As stated above, in the illustrative embodiment, at least one of the first and second sensors 25 and 26, or sheet sensing means, is so positioned as to be able to sense a paper sheet remaining in the casing 32 of the UV radiating device 29. This, coupled with the fact that the above sensor is made up of an IR emitter and an IR sensor, allows the sensor to surely, reliably sense a sheet jam occurred in the casing 32 without being effected by UV rays emitted from the UV lamps 30.

When a sheet jam occurs in the casing 32, a controller, not shown, included in the stencil printer immediately stops applying power to the UV lamps 30 to thereby turn them off. However, because remaining heat of the UV lamps 30 still acts on the paper sheet A, the paper sheet A should preferably be positively driven 11: out of the stencil printer after the turn-off of the UV lamps 30.

As for the detection of the jamming paper sheet A, it is most important to sense the paper sheet A entered the casing 32 of the UV radiating device 29 and staying therein without being discharged. To surely sense such a paper sheet A, in the illustrative embodiment, at last one of a plurality of sensors included in the conveyor 18 is positioned in the casing 32 of the UV radiating device 29 and implemented as a transmission type sensor made up of a light emitting device and a light-sensitive device, as distinguished from a reflection type sensor responsive to light reflected from a paper sheet and therefore apt to bring about an error. More specifically, in the illustrative embodiment, while the IR emitter 26a emits IR rays, the IR sensor 26b senses the IR rays for thereby sensing the paper sheet A. Preferably, a plurality of sensors should be arranged in the casing 32.

When the paper sheet A, jamming the sheet path 100 in the casing 32 of the UV radiating device 29, is sensed, it is necessary to protect the paper sheet A from discoloring, waving or similar damage, as stated previously. For this purpose, when such a sheet jam is detected, the illustrative embodiment immediately turns off the UV lamps 30, displays a jam alarm, and continuously drives the belt 21 for a preselected extra period of time long enough for the paper sheet A to be driven out of the casing 32 for thereby promoting the discharge of the paper sheet A.

Further, the belt 21 is driven at higher speed than usual in order to convey the paper sheet A with a greater force. For this purpose, the rotation speed of the drive motor 22, for example, may be increased. If desired, power applied to the suction fan 24 may be increased in order to increase the sucking force and therefore conveying force thereof in place of or in addition to the rotation speed of the drive motor 22.

As shown in FIG. 2, when the leading edge of the paper sheet A is caught by part of the reflector 38 or part of the casing 32, the openable cover 34, obstructing the discharge of the paper sheet A may be opened in the direction 101. In such a case, the conveyor 18 is continuously driven for a preselected period of time to thereby rapidly discharge the jamming paper sheet A.

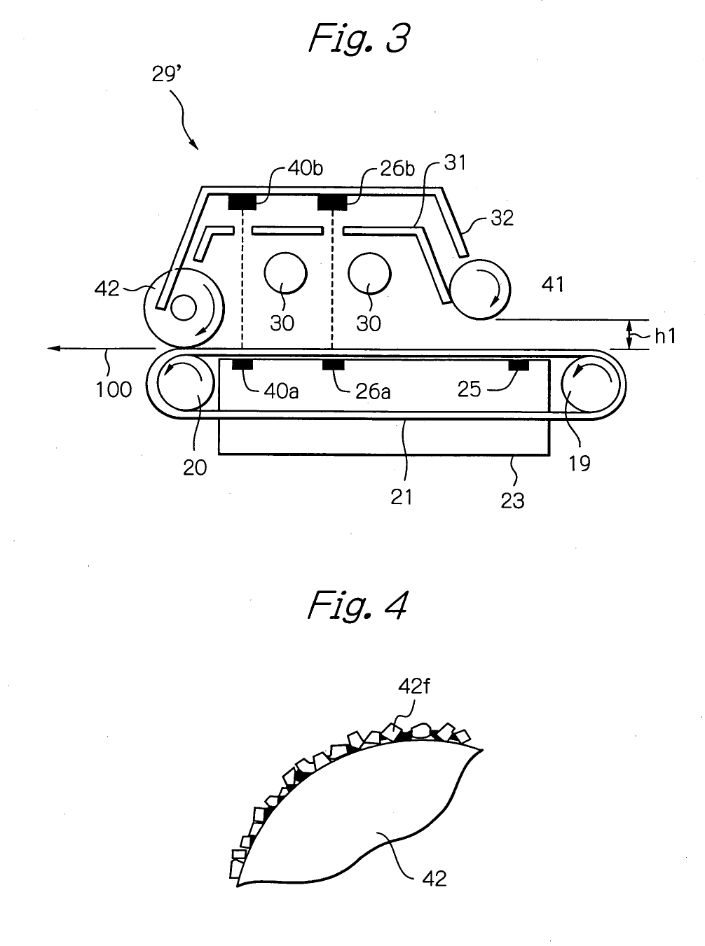

Reference will be made to FIG. 3 for describing a modification of the UV radiating device 29 of the illustrative embodiment. In FIG. 3, structural parts and elements identical with those shown in FIGS. 1 and 2 are designated by identical reference numerals. As shown, a UV radiating device, generally 29′, also includes two UV lamps 30 positioned parallel to each other in the direction 100, the reflector 31 surrounding the UV lamps 30 and the casing 32 surrounding the reflector 31. In the modification, two holes are formed in the reflector 31 while two IR sensors 26b and 40b are positioned outside of the reflector 31.

A guide roller 41 is positioned at the upstream side of the casing 32, facing the endless belt 21, in order to surely guide the paper sheet into the UV radiating device 29′ and is formed of heat-resistant metal. The guide roller 41 is spaced from the outside surface of the belt 21 by the gap h1 and therefore usually prevented from contacting the image surface of the paper sheet. However, in order to prevent the guide roller 41 from catching, e.g., a corner of the paper sheet curled upward, the guide roller 41 is driven by a drive source, not shown, in a direction indicated by an arrow in FIG. 3. In addition, fine abrasive grains are adhered to the surface of the guide roller 41 in order to protect the roller 41 from smearing ascribable to wet ink even when contacting the image surface of the paper sheet.

An outlet roller 42 is located at the same position as the downstream end of the casing 32, as seen in the direction 100, which is configured to prevent the UV rays from leaking to the outside. The outlet roller 42, also formed of heat-resistant metal, serves to surely guide the paper sheet from the UV radiating device 29′ to the downstream side in the direction 100.

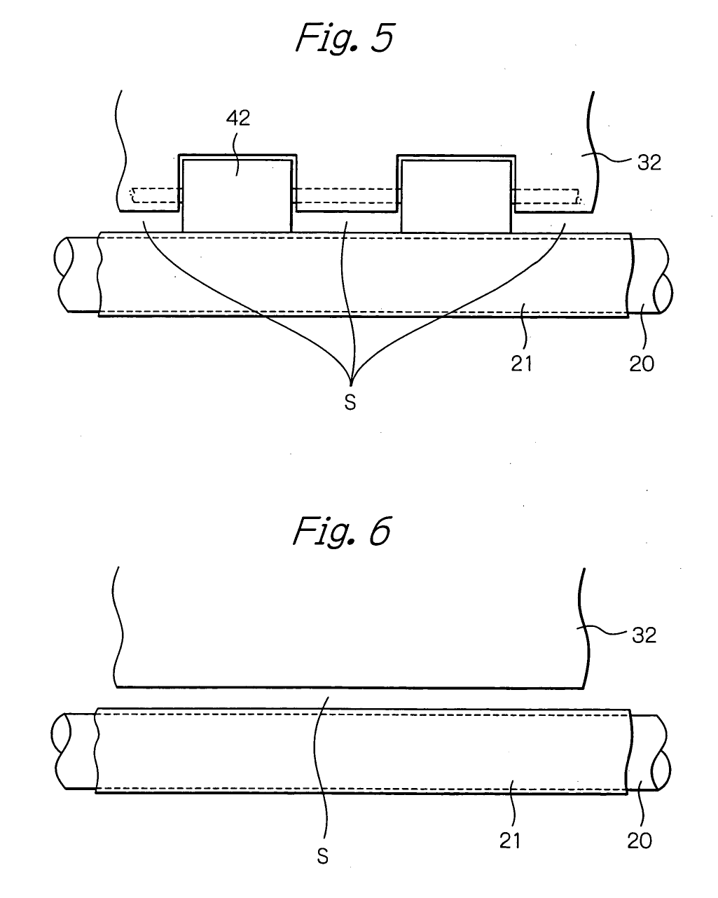

The outlet roller 42 is positioned just above the drive roller 20 in contact with the belt 21 and pressed against the drive roller 20 by a preselected force. In this condition, the outlet roller 42 is caused to rotate by the belt 21 on a friction basis. As shown in FIG. 4, the peripheral surface of the outlet roller 42 is formed with fine irregularity 42f to have its coefficient of friction increased. The irregularity 42f may be implemented by knurling or adhering fine abrasive grains by way of example.

In the above configuration, even a paper sheet curled in the UV radiating device 29′ can be surely driven out by being nipped between the belt 21 and the outlet roller 42. The outlet roller 42 may be driven by a drive source, if desired.

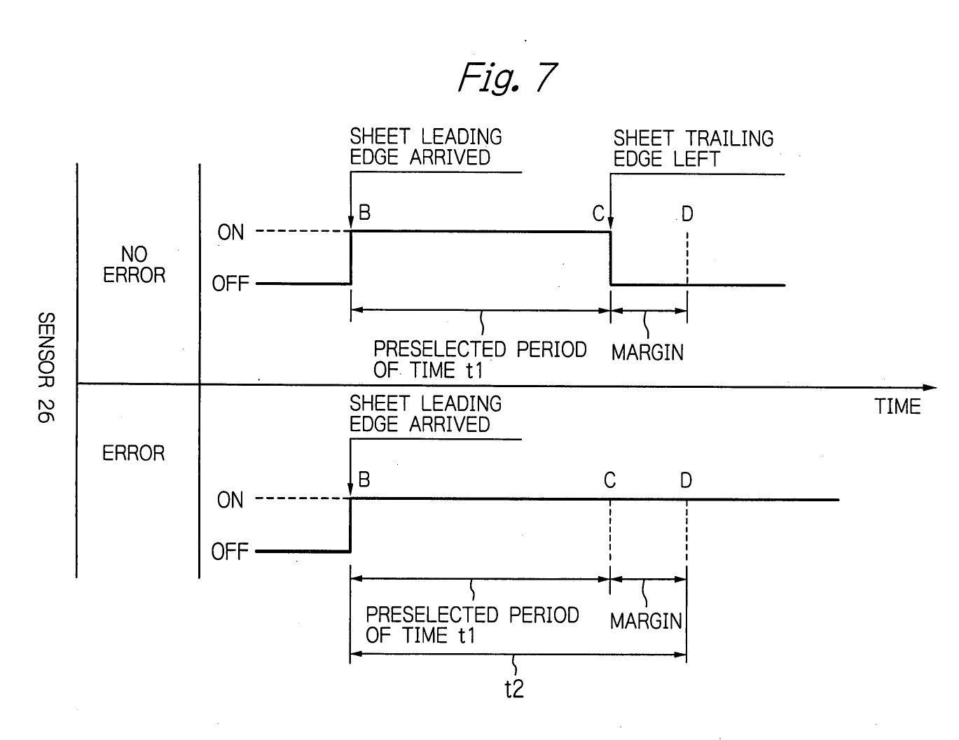

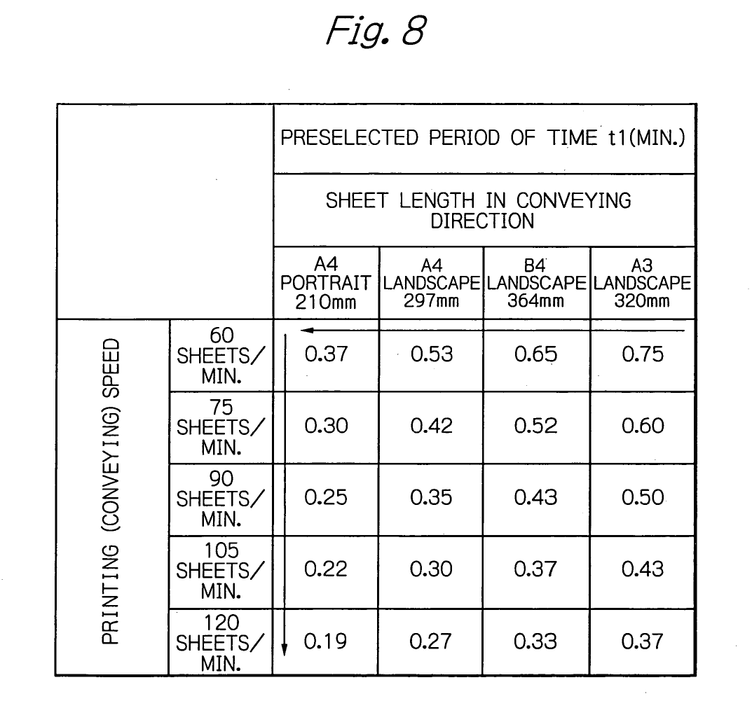

As shown in FIG. 5 which is a view as seen from the left of FIG. 3, the outlet roller 42 is not a single cylindrical roller, but is constituted by a plurality of coaxial roller members. The end portion of the casing 32 is so configured as to be positioned between nearby roller members of the outlet roller 42. By comparing FIG. 5 with FIG. 6 in which the outlet roller 42 is absent, it will be seen that the total area of the space S between the edge of the casing 32 and the upper surface of the belt 21 is smaller in FIG. 5 than in FIG. 6, reducing the amount of UV rays to leak to the outside.

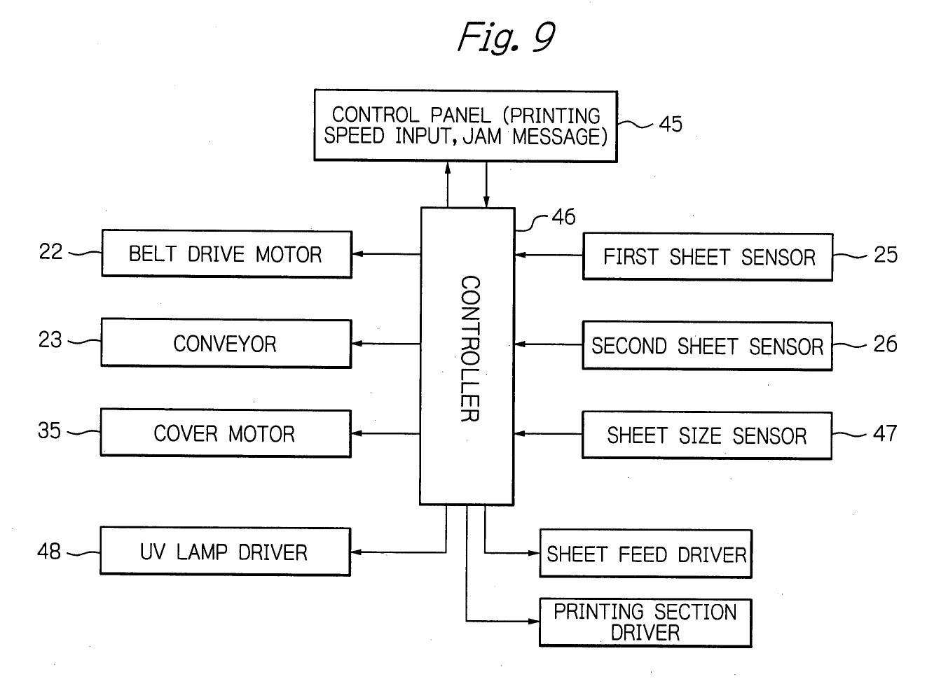

FIG. 7 is a timing chart demonstrating the operation of the second sensor 26, FIG. 2, responsive to the paper sheet A that may remain in the UV radiating device 29. As shown, the second sensor 26, usually remaining in an OFF state, goes ON at a time B on detecting the leading edge of the paper sheet A. Subsequently, the sensor 26 is expected to goes OFF at a time C, which is later than the time B by t1, when the trailing edge of the paper sheet A leaves the sensor 26. Of course, the actual decision on a jam is made at a time D with some margin.

On the other hand, when an error occurs, the sensor 26 remains in the ON state even at the time C. If the sensor 26 does not go OFF even at a time D later than the time B by t2, the controller mentioned earlier determines that a jam has occurred and immediately turns off the UV lamps 30.

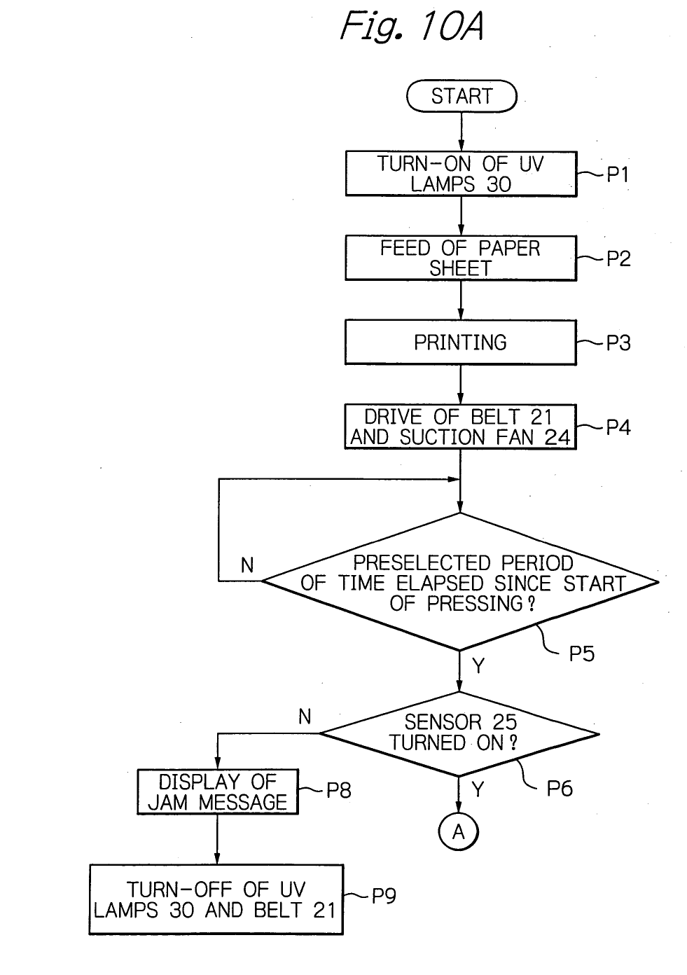

The period of time t1 shown in FIG. 7 is determined in accordance with the sheet conveying speed and the length of a paper sheet in the direction of conveyance 100. FIG. 8 is a table listing specific periods of time t1 each matching with a particular sheet conveying speed and a particular sheet length. As shown, the period of time t1 decreases with an increase in the sheet conveying speed (indicated by a downward arrow in FIG. 8) and a decrease in the sheet length (indicated by a leftward arrow in FIG. 8). The margin is selected to be about 0.3 second to 0.4 second.

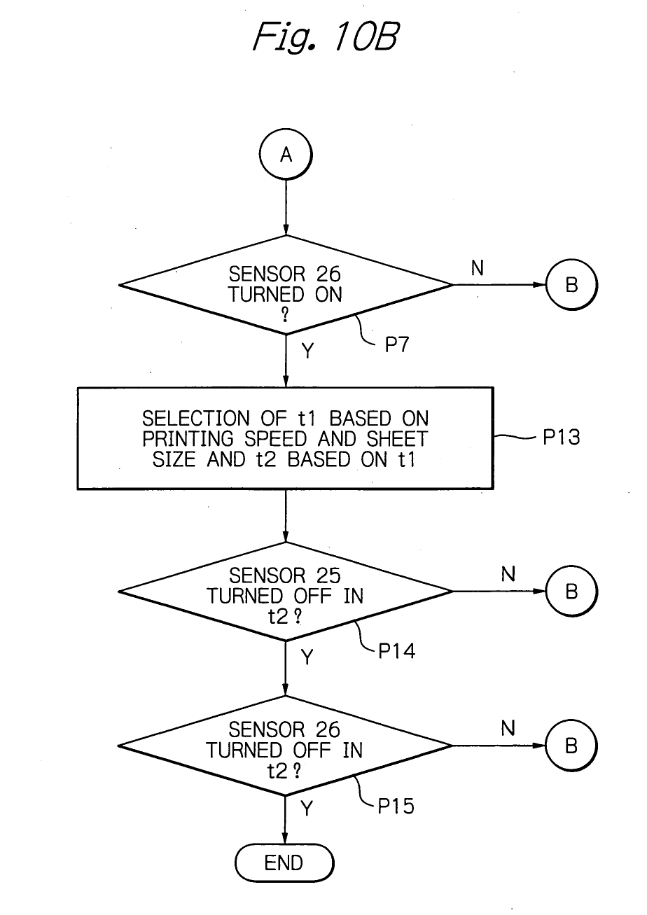

FIG. 9 is a schematic block diagram showing a control system included in the illustrative embodiment. As shown, the controller, labeled 46, is mounted on the body of the stencil printer. The controller 46 determines the length of a paper sheet in the direction of sheet conveyance in accordance with data fed from a sensor 47, which is mounted on the sheet feed table 1 and responsive to the size of paper sheets stacked thereon. At the same time, the controller 46 determines a printing speed output from a print speed key and selected by the operator of the stencil printer, thereby selecting adequate periods of time t1 and t2 listed on the table of FIG. 8.

Subsequently, the controller 46 determines whether or not a paper sheet has been successfully conveyed in accordance with the outputs of the first and second sensors 25 and 26. If the conveyance is not successful, the controller 46 immediately causes a UV lamp driver 48 to output a lamp OFF command. Thereafter, on the elapse of a preselected period of time, e.g., 2 seconds to 3 seconds, the controller 46 drives a motor 35 for opening the openable cover 34.

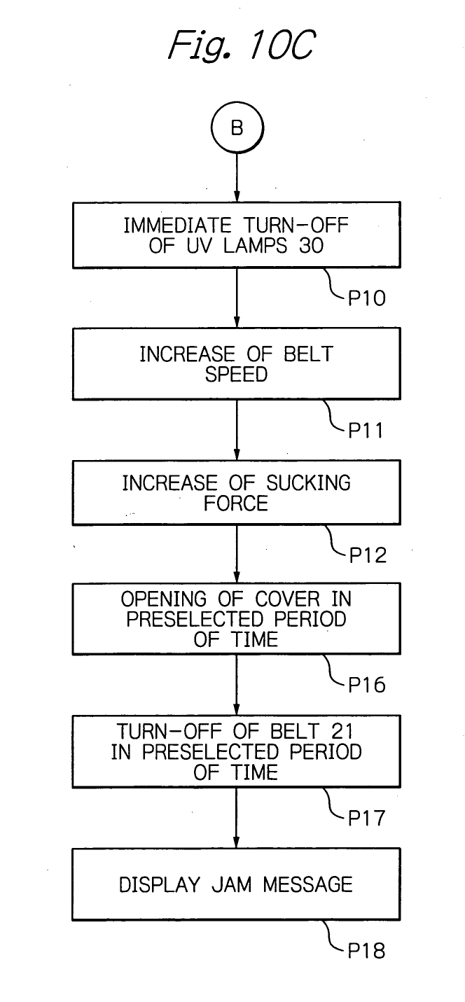

A specific operation of the control system will be described with reference to FIGS. 10A-10C. As shown, when the operator presses a print start key positioned on the printer body, the UV lamp driver 48 applies power to the UV lamps 30 first of all (step P1) This is because a certain period of time is necessary for the output of the UV lamps 30 to be stabilized. After the turn-on of the UV lamps 30, there are executed a step of peeling off a used document from the print drum 10 and a step of making a master by perforating a stencil in accordance with image data, although not shown specifically. The master is then wrapped around the print drum 10.

Subsequently, the top paper sheet on the sheet feed table 1 is fed toward the print position P while being separated from the underlying paper sheets (step P2), and then the press roller 11 pressed the paper sheet brought to the print position P against the master for thereby printing an image on the paper sheet (step P3).

The paper sheet or print, carrying the image transferred thereto, is peeled off from the drum 10 and prepared for conveyance toward the print tray 27 by the turning of the belt 21 and the sucking force of the suction fan 24 (step P4).

After the step P4, the controller 46 determines whether or not the preselected period of time has elapsed since the pressing of the press roller 11 against the paper sheet (step P5). If the answer of the step P5 is positive, Y, the controller 46 references the outputs of the two sensors 25 and 26 for determining whether or not the print is being successfully conveyed toward the print tray 27 (steps P6 and P7).

More specifically, when the preselected period of time elapses since the pressing of the press roller 11 (Y, step P5) the controller 46 determines whether or not the sensor 25 has turned on by sensing the leading edge of the paper sheet (step P6). If the answer of the step P6 is negative, N, the controller 46 determines that some error has occurred before the arrival of the paper sheet at the UV radiating device 29 (29′), i.e., at a position short of the sensor 25, and displays a jam message on, e.g., a control panel. 45 (step P8), turns off the UV lamps 30 and stops driving the belt 21 (step P9). At this instant, the suction fan 24 may not be turned off.

If the answer of the step P6 is Y, the controller 46 determines whether or not the other sensor 26 has turn on (step P7). If the answer of the step P7 is N, the controller 46 determines that some error has occurred before the paper sheet, moved away from the sensor 25, arrives at the sensor 26. In this case, because the paper sheet may have been conveyed as far as the UV radiating device 29 (29′), the controller 46 immediately turns off the UV lamps 30 (step P10) and then increases the speed of he belt 21 (step P11) and/or the sucking force of the fan 24 (step P12) in order to rapidly discharge the jamming paper sheet.

On the other hand, the controller 46 selects an adequate period of time t1 matching with the sheet size information and printing speed information out of the table of FIG. 8, and then adds an adequate margin to the period of time t1 for thereby determining a period of time t2 (step P13).

The sensor. 25, turned on (Y, step S6), is expected to turn off at least on the elapse of the period of time t2. In light of this, the controller 46 determines whether or not the sensor 25 has turned off on the elapse of the period of time t2 (step P14). If the answer of the step P14 is N, the controller 46 determines that some error has occurred, and again increases the speed of the belt 21 and/or the sucking force of the suction fan 24 (steps P10 through P12).

The sensor 26, like the sensor 25, is expected to turn off at least on the elapse of the period of time t2. In light of this, the controller 46 determines whether or not the sensor 26 has turned off on the elapse of the period of time t2 (step P15). If the answer of the step P15 is N, the controller 46 determines that an error has occurred in the UV radiating device 29 (29′), immediately turns off the UV lamps 30, increases the speed of the belt 21 and/or the sucking force of the suction fan 24 for rapidly discharging the jamming paper sheet (steps P10 through P12) and opens the openable cover 34 (step P16).

After the step P16, the controller 46 continuously drives the belt 21 and suction fan 24 for a preselected period of time and then stops driving them (step P17) while displaying a jam message on the control panel 45 (step P18). If the sensor 26 turns off on the elapse of the above period of time, the controller 46 may determine that the jamming sheet has been entirely driven out of the UV radiating device 29 (29′), and allow the printing operation to be continued, although not shown specifically.

As stated above, the illustrative embodiment and modification thereof achieves various unprecedented advantages, as enumerated below.

(1) The UV lamps 30 are turned off first of all in order to reduce damage to a paper sheet after a jam as far as possible.

(2) A decision on a jam, which is determined by the printing speed and sheet size, can be executed at the earliest possible time, allowing a jam to be detected at the earliest possible stage.

(3) The endless belt 21 is continuously driven after the turn-off of the UV lamps 30 so as to promote the discharging of a paper sheet remaining in the UV radiating device 29 (29′). Also, the drive of the belt 21 and that of the suction fan 24 serve to lower temperature in the UV radiating device.

(4) The force for driving the paper sheet out of the UV radiating device 29 (29′) can be increased to discharge the paper sheet as rapidly as possible.

(5) Even when the paper sheet is caught by the casing 32 of the UV radiating device 29 (29′), it can be successfully driven out of the casing 32.

(6) Irregularity is formed on the surface of a roller in order to increase the coefficient of friction, so that even a paper sheet curled upward can be surely driven out.

(7) A gap in the outlet portion of the UV radiating device 29 (29′) is reduced. This, coupled with the fact that belt 21 conveys the paper sheet from the UV radiating device 29 (29′) toward the print tray 27 by nipping it, ensures the discharge of the paper sheet from the device 29 (29′).

In summary, in accordance with the present invention, at least one of sheet sensing means is so positioned as to sense a paper sheet remaining in the casing of a UV radiating device and implemented as a transmission type sensor made up of an IR emitter and an IR sensor. Such a sheet sensing means can therefore surely detect a sheet jam occurred in the UV radiating device without being effected by UV rays emitted from UV lamps included in the UV radiating device.

Various modifications will become possible for those skilled in the art after receiving the teachings of the present disclosure without departing from the scope thereof.

What is claimed is:

1. A stencil printer comprising:
stencil printing means comprising a hollow, cylindrical print drum around which a master is to be wrapped;
conveying means for conveying a sheet moved away from said stencil printing means;
UV (Ultraviolet) radiating means facing said conveying means for radiating UV rays toward an image surface of the sheet; and
a plurality of sheet sensing means included in said conveying means for sensing a passage of the sheet through said UV radiating means;
wherein at least one of said plurality of sheet sensing means is so positioned as to be able to determine whether or not the sheet is remaining in a casing of said UV radiating means and comprises transmission type sensing means made up of an IR (InfraRed) emitter and an IR sensor.

2. The stencil printer as claimed in claim 1, wherein when said sheet sensing means responsive to the paper sheet remaining in said casing of said UV radiating means does not sense a passage of the sheet at a preselected timing, UV lamps included in said UV radiating means are immediately turned off while a jam message is displayed.

3. The stencil printer as claimed in claim 2, wherein the preselected timing is determined in accordance with a sheet conveying speed and a sheet size.

4. A stencil printer comprising:
stencil printing means comprising a hollow, cylindrical print drum around which a master is to be wrapped;
conveying means for conveying a sheet moved away from said stencil printing means;
UV radiating means facing said conveying means for radiating UV rays toward an image surface of the sheet;
sheet sensing means included in said conveying means for sensing a passage of the sheet through said UV radiating means; and
control means for immediately turning off, when said sheet sensing means determines that the sheet is not accurately passed through said UV radiating means, UV lamps included in said UV radiating means, continuously driving said conveying means for a preselected period of time after turn-off of said UV lamps, and stopping driving said conveying means on the elapse of said preselected period of time.

5. The stencil printer as claimed in claim 4, wherein when said sheet sensing means determines that the sheet is not accurately passed through said UV radiating means, said control means immediately turns off said UV lamps, drives said conveying means at a higher speed than before turn-off of said UV lamps and stops driving said conveying means in a preselected period of time since said turn-off of said UV lamps.

6. The stencil printer as claimed in claim 4, wherein said conveying means comprises a belt for exerting a conveying force on the sheet and air sucking means sucking an underside of said sheet during conveyance, and when said sheet sensing means determines that the sheet is not accurately passed through said UV radiating means, said control means immediately turns off said UV lamps, makes a sucking force of said air sucking means greater than before turn-off of said UV lamps and stops driving said conveying means in a preselected period of time since said turn-off of said UV lamps.

7. The stencil printer as claimed in claim 4, wherein said UV radiating means comprises UV lamps and a cover member surrounding said UV lamps, part of said cover member is openable by being electrically driven, and said control means opens said cover member on the elapse of the preselected period of time since the turn-off of said UV lamps and then stops driving said conveying means on the elapse of another preselected period of time.

8. The stencil printer as claimed in claim 4, wherein said conveying means comprises an endless belt passed over two rollers and implemented by a plurality of thin metallic sheets, air sucking means for sucking an underside of the sheet to thereby cause said underside to contact said endless belt, and an outlet roller positioned at a downstream side in a direction of sheet conveyance and having a surface formed with irregularity.

9. The stencil printer as claimed in claim 8, wherein said outlet roller is so positioned as to exert a conveying force on the sheet by nipping said sheet in cooperating with said endless belt and is located at a same position as said cover member configured to prevent UV rays from leaking to an outside at a downstream side in the direction of sheet conveyance.

10. A stencil printer comprising:
stencil printing means comprising a hollow, cylindrical print drum around which a master is to be wrapped;
a conveyor constructed to convey a sheet moved away from said stencil printing means;
a UV radiating device facing said conveyor and configured to radiate UV rays toward an image surface of the sheet; and
sheet sensing means included in said conveyor for sensing a passage of the sheet through said UV radiating device;
wherein at least one of said sheet sensing means is so positioned as to be able to determine whether or not the sheet is remaining in a casing of said UV radiating device and comprises transmission type sensing means made up of an IR emitter and an IR sensor.

11. The stencil printer as claimed in claim 10, wherein when said sheet sensing means responsive to the paper sheet remaining in said casing of said UV radiating device does not sense a passage of the sheet at a preselected timing, UV lamps included in said UV radiating device are immediately turned off while a jam message is displayed.

12. The stencil printer as claimed in claim 11, wherein the preselected timing is determined in accordance with a sheet conveying speed and a sheet size.

13. A stencil printer comprising:
stencil printing means comprising a hollow, cylindrical print drum around which a master is to be wrapped;
a conveyor configured to convey a sheet moved away from said stencil printing means;
a UV radiating device facing said conveying means and configured to radiate UV rays toward an image surface of the sheet;
sheet sensing means included in said conveyor for sensing a passage of the sheet through said UV radiating device; and
a controller configured to immediately turn off, when said sheet sensing means determines that the sheet is not accurately passed through said UV radiating device, UV lamps included in said UV radiating device, continuously drive said conveyor for a preselected period of time after turn-off of said UV lamps, and stop driving said conveyor on the elapse of said preselected period of time.

14. The stencil printer as claimed in claim 13, wherein when said sheet sensing means determines that the sheet is not accurately passed through said UV radiating device, said controller immediately turns off said UV lamps, drives said conveyor at a higher speed than before turn-off of said UV lamps and stops driving said conveyor in a preselected period of time since said turn-off of said UV lamps.

15. The stencil printer as claimed in claim 13, wherein said conveyor comprises a belt for exerting a conveying force on the sheet and air sucking means sucking an underside of said sheet during conveyance, and when said sheet sensing means determines that the sheet is not accurately passed through said UV radiating device, said controller immediately turns off said UV lamps, makes a sucking force of said air sucking means greater than before turn-off of said UV lamps and stops driving said conveyor in a preselected period of time since said turn-off of said UV lamps.

16. The stencil printer as claimed in claim 13, wherein said UV radiating device comprises UV lamps and a cover member surrounding said UV lamps, part of said cover member is openable by being electrically driven, and said controller opens said cover member on the elapse of the preselected period of time since the turn-off of said UV lamps and then stops driving said conveyor on the elapse of another preselected period of time.

17. The stencil printer as claimed in claim 13, wherein said conveyor comprises an endless belt passed over two rollers and implemented by a plurality of thin metallic sheets, air sucking means for sucking an underside of the sheet to thereby cause said underside to contact said endless belt, and an outlet roller positioned at a downstream side in a direction of sheet conveyance and having a surface formed with irregularity.

18. The stencil printer as claimed in claim 17, wherein said outlet roller is so positioned as to exert a conveying force on the sheet by nipping said sheet in cooperating with said endless belt and is located at a same position as said cover member configured to prevent UV rays from leaking to an outside at a downstream side in the direction of sheet conveyance.
